(19) United States
(12) Patent Application Publication
(10) Pub. No.: US 2005/0149773 A1
(43) Pub. Date: Jul. 7, 2005

(54) Energy conservation method and mechanism for gaming/arcade/vending/transaction/kiosk machines

(76) Inventor: Connie L. Kevan, Brainerd, MN (US)

Correspondence Address: Richard C. Litman;LITMAN LAW OFFICES, LTD., P.O. Box 15035, Arlington, VA, 22215, US

(21) Appl. No.: 11/023,429

(22) Filed: Dec. 29, 2004

Related U.S. Application Data
(60) Provisional application No. 60/534,101, filed on Jan. 5, 2004.

(51) Int. Cl. G06F 1/32

(52) U.S. Cl. 713/320

(57) ABSTRACT

An energy conservation method and/or mechanism for gaming, arcade, vending, transaction, and/or kiosk machines. Gaming, arcade, or vending machines equipped with the energy conservation mechanism remain in a FULL POWER mode when credits remain on the machines. When credits are at zero for a predetermined amount of time, the gaming, arcade, or vending machines automatically go into a LOW ENERGY mode. Using credits to determine the energy mode of the gaming, arcade, or vending machines prevents possible problems such as loss of credits to the user, due to the machine going into the LOW ENERGY mode. Transaction or kiosk machines return to the FULL POWER mode when the monetary value is sensed or detected. The transaction and kiosk machines return to the LOW ENERGY mode when monetary value is not detected for a predetermined period of time.

### CROSS-REFERENCE TO RELATED APPLICATION

This application claims the benefit of U.S. Provisional Patent Application Ser. No. 60/534,101, filed Jan. 5, 2004, which is incorporated herein by reference.

### BACKGROUND OF THE INVENTION

1. Field of the Invention

The present invention generally relates to gaming machines and equipment, and vending, arcade, kiosk, and transaction machines and, more particularly, to an energy conservation method and/or mechanism for gaming, arcade, vending, transaction, and/or kiosk machines.

2. Description of Related Art

Casino revenues generated by gaming machines, such as slot machines, typically account for over fifty percent of casino earnings. However, such gaming machines are not in constant use. Maintaining the gaming machines in a perpetually active state results in high electrical costs and tends to offset earning revenue. During hot weather, many communities are faced with becoming more common and this dilemma will only increase in the future. If large businesses recognize this and cut back their electrical usage, their profits will increase, and their surrounding communities and the environment will benefit.

Arcade, vending, kiosk, and transaction machines (e.g., Automated Teller Machines (ATMs), Percontas, etc.) are also subject to being constantly activated and having high electrical costs. A need exists for providing an energy conservation method and/or method for gaming/arcade/vending/transaction/kiosk machines that converts their energy usage into a LOW ENERGY mode. Machines equipped with such an energy conservation mechanism will use less electricity, with dimmer lighting, and may be configures with a screen saver that alerts users that the business is community friendly and environmentally concerned. Such a machine will go into an energy conservation mode when not utilized for a predetermined amount of time, and will reactivate into a FULL POWER mode when utilized.

### SUMMARY OF THE INVENTION

The present invention an energy conservation method or mechanism for gaming, arcade, vending, transaction, and/or kiosk machines. The energy conservation method equips a machine with an energy conservation mechanism, a LOW ENERGY mode circuit, and a FULL POWER mode circuit; places the machine in a FULL POWER mode when credits greater than zero appear on the machine or when coins/tokens, cash bills, credit cards, telephone calling cards, ATM cards, smart cards, vouchers, or touch are detected being entered into the machine; and places the machine in a LOW ENERGY mode when zero credits appears on the credit display and coins/tokens, cash bills, credit cards, telephone calling cards, ATM cards, smart cards, vouchers have not been detected being entered into the machine for a predetermined period of time. The energy conservation mechanism has energy saving circuitry that can include a coin acceptor, a bill acceptor, a magnetic strip reader, a bar code scanner, a credit display, control logic, memory, an energy conservation mechanism, a LOW ENERGY mode circuit, a FULL POWER mode circuit, a power supply, and a communication bus.

Gaming, arcade, or vending machines equipped with the energy conservation mechanism remain in a FULL POWER mode when credits remain on the machines. When credits are at zero for a predetermined amount of time, the gaming, arcade, or vending machines automatically go into a LOW ENERGY mode. Using credits to determine the energy mode of the gaming, arcade, or vending machines prevents possible problems, such as loss of credits to the user, due to the machine(s) going into the LOW ENERGY mode.

Transaction or kiosk machines return to the FULL POWER mode when the coins/tokens, cash bills, credit cards, telephone calling cards, ATM cards, smart cards, vouchers, tickets, or touch are detected. The transaction and kiosk machines return to the LOW ENERGY mode when coins/tokens, cash bills, credit cards, telephone calling cards, ATM cards, smart cards, vouchers, tickets, touch, or the like, are not detected for a predetermined period of time.

The energy conservation mechanism is configured to determine whether a number of credits greater than zero appears on the machine. When the number of credits that appears on the machine is greater than zero, the machine remains in a FULL POWER mode. When the number of credits that appears on the machine is equal to zero, and coins/tokens, cash bills, credit cards, telephone calling cards, ATM cards, smart cards, vouchers, tickets, touch, or the like, have not been sensed and/or detected being inserted into the machine, the machine goes into a LOW ENERGY mode.

### BRIEF DESCRIPTION OF THE DRAWINGS

FIG. 1 is an environmental, perspective view of series of slot machines that are fully active or are in a LOW ENERGY mode according to the present invention.

FIG. 2A is a front view of a slot machine that is in a LOW ENERGY mode according to the present invention.

FIG. 2B is a graphical illustration indicating the energy usage of the slot machine shown in FIG. 2A as it goes from a FULL POWER mode to a LOW ENERGY mode according to the present invention.

FIG. 3A is a front view of a slot machine that is in a full power mode according to the present invention.

FIG. 3B is a graphical illustration indicating the energy usage of the slot machine shown in FIG. 3A as it goes from a LOW ENERGY mode to a FULL POWER mode according to the present invention.

FIG. 4 is a block diagram of a slot machine that may be in a LOW ENERGY mode or a FULL POWER mode according to the present invention.

Similar reference characters denote corresponding features consistently throughout the attached drawings.

### DETAILED DESCRIPTION OF THE PREFERRED EMBODIMENTS

The present invention is an energy conservation method and/or mechanism for gaming, arcade, vending, transaction, and/or kiosk machines. The invention disclosed herein is, of course, susceptible of embodiment in many different forms. Shown in the drawings and described herein below in detail are preferred embodiments of the invention. It is to be understood, however, that the present disclosure is an exemplification of the principles of the invention and does not limit the invention to the illustrated embodiments.

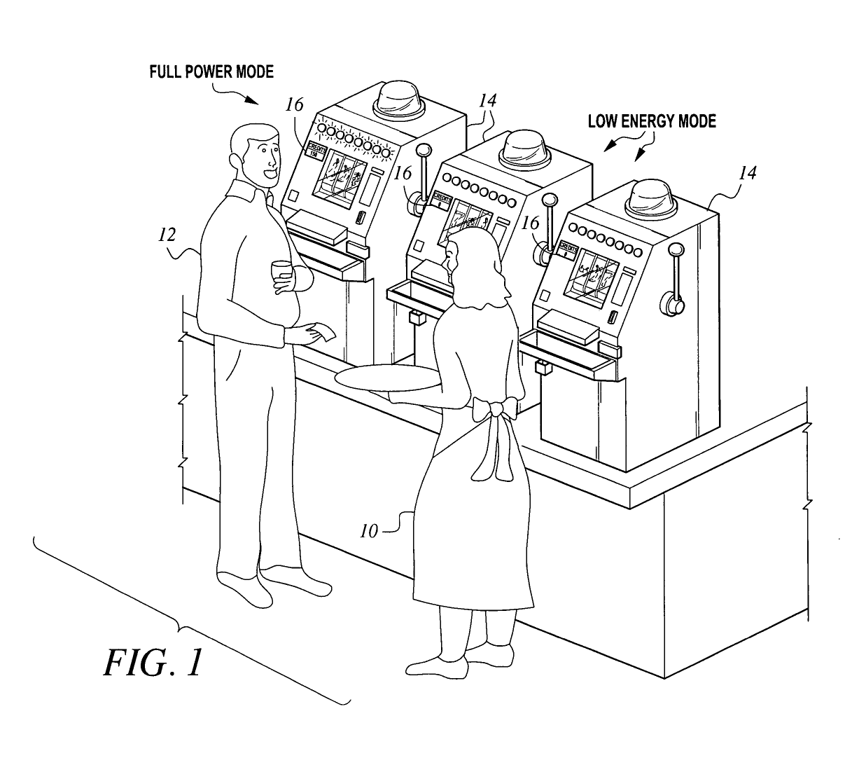

Referring to the drawings, FIG. 1 shows a casino layout with a waitress 10 receiving payment for a drink from a customer 12. The customer 12 had been playing the slot machine 14 that is in a FULL POWER mode, as indicated by the credit display 16 showing a number of credits greater than zero on the slot machine 14. The other slot machines 14 are in an energy conservation or LOW ENERGY mode as indicated by their credit displays 16 that show the number of credits as being zero. While the following description is directed toward a particular gaming machine, e.g., a slot machine, it is the full intent of the inventor that the energy conservation mechanism disclosed herein may be applied to any type of gaming, arcade, vending, kiosk, or transaction machine. In addition, the energy conservation mechanism can be utilized in new or future machines, and existing machines or equipment can be retrofitted with the energy conservation mechanism.

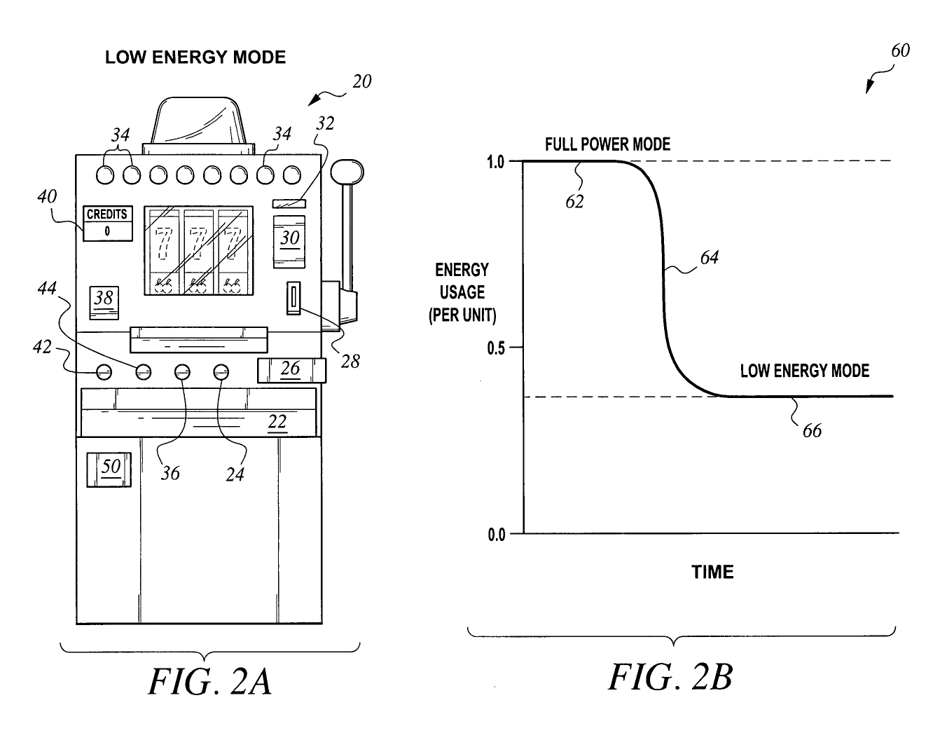

FIG. 2A illustrates an example of a slot machine 20 equipped with an energy conservation mechanism according to the invention (any known gaming, arcade, vending, kiosk, or transaction machine may be similarly configured). The slot machine 20 includes a credit display 40 indicating that the slot machine 20 has zero credits. Because the slot machine 20 has zero credits, the slot machine 20 is in a LOW ENERGY mode. As illustrated, the slot machine 20 includes a coin/token tray 22, a stop button 24, a door/reset lock 26, a coin/token entry 28, a win meter 30, a replay lock 32, a flashing light bar 34, a credit play button 36, a credit collection button 38, a credit display 40, a reel start button 42, and an ashtray 50. However, aside from the credit display 40, the slot machine 20 may include any variety of buttons, indicators, accessories, or the like. FIG. 2B illustrates the slot machine 20 as it transfers from a FULL POWER mode 62 to a LOW ENERGY mode 66.

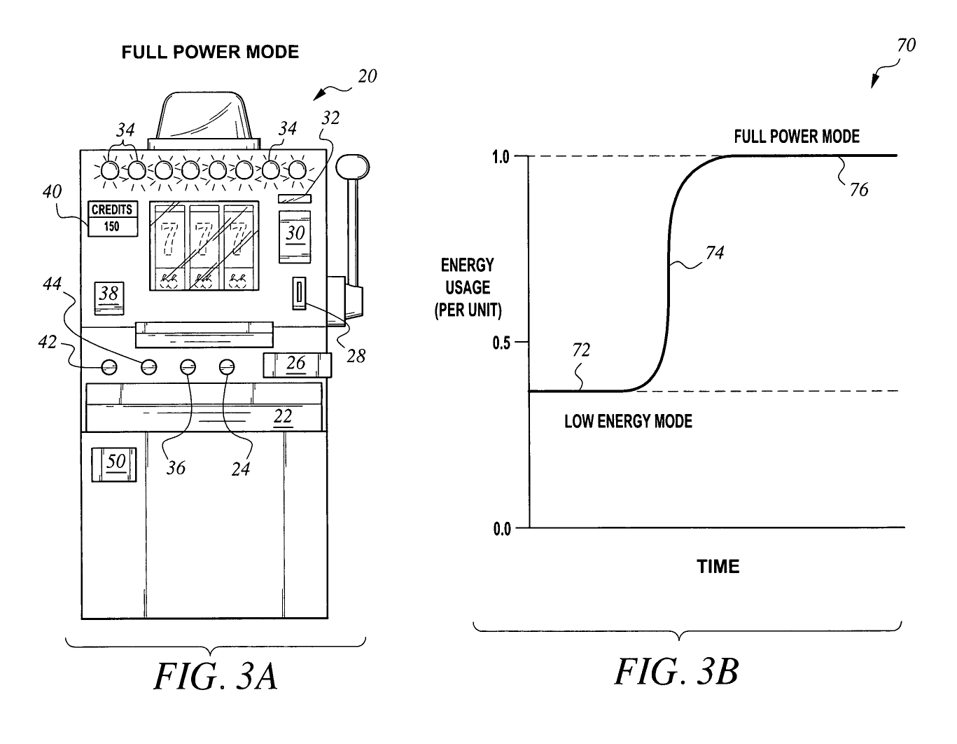

FIG. 3A illustrates the slot machine 20 shown in FIG. 2A in a FULL POWER mode. The slot machine 20 includes a credit display 40 indicating that the slot machine 20 has a number of credits, in this case one hundred and fifty credits. Because the slot machine 20 has a number of credits greater than zero, the slot machine 20 is in a FULL POWER mode. The slot machine 20 is in a FULL POWER mode because the slot machine 20 has one hundred and fifty credits and because the slot machine credit display 40 has been active within a predetermined period of time, such as five minutes or the like. FIG. 3B illustrates the slot machine 20 as it transfers from a LOW ENERGY mode 72 to a FULL POWER mode 76.

The slot machine 20 may also be configured for accepting payment in other ways, such as with cash bills, credit cards, telephone calling cards, ATM cards, smart cards, etc., via the use of corresponding readers. Payouts from the slot machine 20 may also be generated in an associated manner. For example, the payout may be provided to the customer as a printed voucher that can be redeemed at a casino pay booth. The slot machine 20 may also have an ATM type of interface that includes reader that reads the magnetic strip of an ATM card or credit card, and a numerical keypad into which the user can input his/her personal identification number (PIN) so as to authorize the use of the associated card for the particular transaction. The ATM interface then communicates with a remote financial institution over telephone wires.

Gaming, arcade, or vending machines equipped with the energy conservation mechanism remain in FULL POWER mode when credits remain on the machines. When credits are at zero for predetermined amount of time, the gaming, arcade, or vending machines automatically go into the LOW ENERGY mode. Using credits to determine the energy mode of the gaming, arcade, or vending machines prevents possible problems such as loss of credits t the user, due to the machine going into the LOW ENERGY mode.

Unlike gaming, arcade, or vending machines, which use credits to determine the energy mode of the machines when equipped with the energy conservation mechanism, transaction or kiosk machines return to the FULL POWER mode when the coins/tokens, cash bills, credit cards, telephone calling cards, ATM cards, smart cards, vouchers, tickets, touch, etc., are sensed or detected. The transaction and kiosk machines return to the LOW ENERGY mode when coins/tokens, cash bills, credit cards, telephone calling cards, ATM cards, smart cards, vouchers, tickets, touch, etc., are not detected for a predetermined period of time.

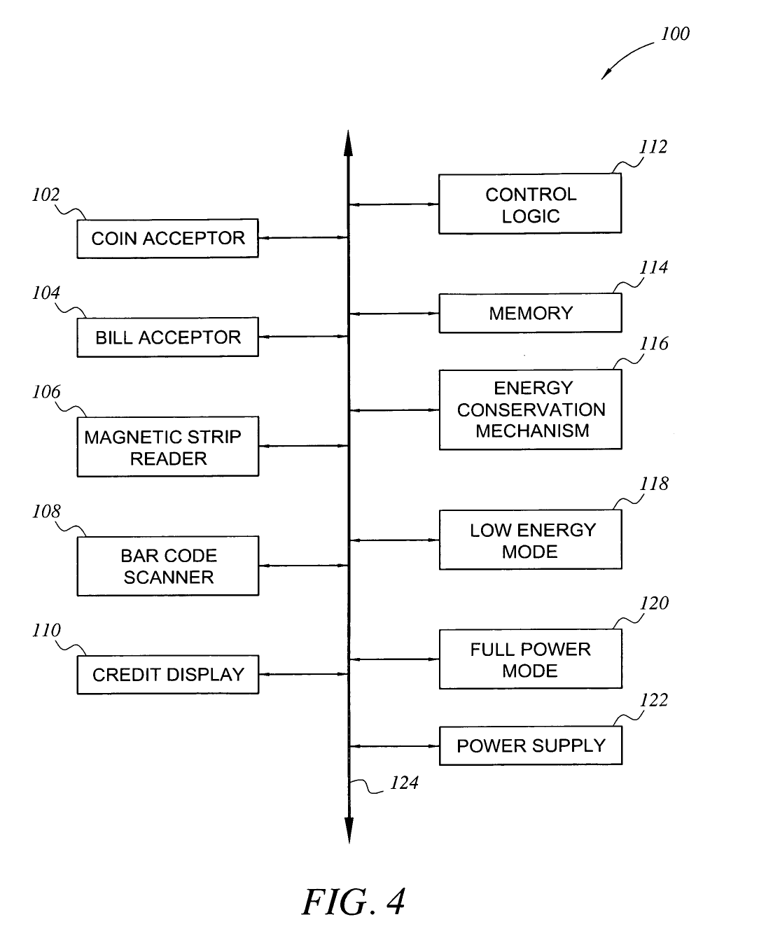

FIG. 4 shows a block diagram of a machine 100 equipped with energy saving circuitry including an energy conservation mechanism 116 according to the invention. The machine 100 can include a coin acceptor 102, a bill acceptor 104, a magnetic strip reader 106, a bar code scanner 108, a credit display 110, control logic 112, memory 114, an energy conservation mechanism 116, a power supply 120, and a communication bus 122. The coin acceptor 102, bill acceptor 104, magnetic strip reader 106, bar code scanner 108, control logic 112, memory 114, and power supply 120 are well known in the art and need no further discussion.

The energy conservation mechanism 116 is configured to determine whether a number of credits greater than zero appears on the credit display 110. For gaming, arcade, or vending machines equipped with the energy conservation mechanism 116, when the number of credits that appears on the credit display 110 is greater than zero, the machine 100 remains in a FULL POWER mode 120. When the number of credits that appears on the credit display 110 is equal to zero, and coins/tokens, cash bills, credit cards, telephone calling cards, ATM cards, smart cards, or the like, have not been sensed and/or detected being inserted into the machine 100, the machine 100 goes into the LOW ENERGY mode 118.

For a gaming, arcade, or vending machine equipped with the energy conservation mechanism 116, the LOW ENERGY mode 118 occurs when the credit display 110 indicates a value of zero on the machine, and detection of any coin/token, bill, ATM/credit/telephone card magnetic strip, bar code, etc., has not occurred for a predetermined period of time. Obviously, this period of time may be adjusted according to the desires of the machine coordinator. For a kiosk or transaction machine equipped with the energy conservation mechanism 116, when no activity occurs for the predetermined period of time, the machine 100 goes into the LOW ENERGY mode 118. While the gaming, arcade, vending, kiosk, or transaction machine is in the LOW ENERGY mode 118, the machine minimizes the use of electricity.

The energy conservation method and/or mechanism 116 described above will greatly enhance the efficiency and earnings of casinos and/or any operators of similarly configured gaming, arcade, vending, transaction, and/or kiosk machines.

While the invention has been described with references to its preferred embodiments, it will be understood by those skilled in the art that various changes may be made and equivalents may be substituted for elements thereof without departing from the true spirit and scope of the invention. In addition, many modifications may be made to adapt a particular situation or material to the teaching of the invention without departing from its essential teachings.

1. An energy conservation method comprising:
equipping a machine with an energy conservation mechanism, a LOW ENERGY mode circuit, and a FULL POWER mode circuit;
placing the machine in a LOW ENERGY mode when credits greater than zero appear on the machine or when coins/tokens, cash bills, credit cards, telephone calling cards, ATM cards, smart cards, vouchers, or touch are detected being entered into the machine; and
placing the machine in a LOW ENERGY mode when zero credits appears on the credit display and coins/tokens, cash bills, credit cards, telephone calling cards, ATM cards, smart cards, vouchers, tickets, or touch have not been detected being entered into the machine for a predetermined period of time.

2. The method according to claim 1, further comprising selecting a machine from the group consisting of a gaming machine, an arcade machine, and a vending machine.

3. The method according to claim 1, further comprising selecting machine from the group consisting a kiosk machine and a transaction machine.

4. The method according to claim 1, wherein the step of equipping a machine with an energy conservation mechanism, a LOW ENERGY mode circuit, and a FULL POWER mode circuit further comprises equipping the machine with a credit display.

5. The method according to claim 1, wherein the step of equipping a machine with an energy conservation mechanism, a LOW ENERGY mode circuit, and a FULL POWER mode circuit further comprises equipping the machine with control logic, memory, a power supply, and a communication bus.

6. The method according to claim 1, wherein the step of equipping a machine with an energy conservation mechanism, a LOW ENERGY mode circuit, and a FULL POWER mode circuit further comprises equipping the machine with a coin acceptor, a bill acceptor, a magnetic strip reader, and a bar code scanner.

7. The method according to claim 1, wherein the step of placing the machine in a FULL POWER mode when credits greater than zero appear on the machine or when coins/tokens, cash bills, credit cards, telephone calling cards, ATM cards, smart cards, vouchers, or touch are detected being entered into the machine further comprises placing the machine in a the FULL POWER mode when zero appear on the machine.

8. The method according to claim 1, wherein the step of placing the machine in a FULL POWER mode when credits greater than zero appear on the machine or when coins/tokens, cash bills, credit cards, telephone calling cards, ATM cards, smart cards, vouchers, or touch are detected being entered into the machine further comprises placing the machine in a the FULL POWER mode when coins/tokens, cash bills, credit cards, telephone calling cards, ATM cards, smart cards, vouchers, tickets, or touch are detected being entered into the machine.

9. A machine comprising:
an energy conservation mechanism;
a Low ENERGY mode circuit interconnected to the energy conservation mechanism; and
a FULL POWER mode circuit interconnected to the energy conservation mechanism, wherein
the machine is placed in the FULL POWER mode when credits greater than zero appear on the credit display; and
the machine is placed in the LOW ENERGY mode when zero credits appear on the machine and the machine has not been active for a predetermined period of time.

10. The machine according to claim 9, wherein the machine is a gaming machine.

11. The machine according to claim 9, wherein the machine is ar arcade machine.

12. The machine according to claim 9, wherein the machine is a vending machine.

13. The machine according to claim 9, further comprising a credit display.

14. The machine according to claim 9, further comprising control logic, memory, a power supply, and a communication bus.

15. The machine according to claim 9, further comprising a coin acceptor, a bill acceptor, a magnetic strip reader, and a bar code scanner.

16. A machine comprising:
an energy conservation mechanism;
a LOW ENERGY mode circuit interconnected with the energy conservation mechanism; and
a FULL POWER mode circuit interconnected with the energy conservation mechanism, wherein
the machine is placed in the FULL POWER mode when coins/tokens, cash bills, credit cards, telephone calling cards, ATM cards, smart cards, vouchers, tickets, or touch, are detected as being entered into the machine; and
the machine is placed in the LOW ENERGY mode when coins/tokens, cash bills, credit cards, telephone calling cards, ATM cards, smart cards, vouchers, tickets, or touch have not been detected being entered into the machine for a predetermined period of time.

17. The machine according to claim 16, wherein the machine is a transaction machine.

18. The machine according to claim 16, wherein the machine is a kiosk machine.

19. The machine according to claim 16, further comprising further comprising control logic, memory, a power supply, and a communication bus.

20. The machine according to claim 16, further comprising a coin acceptor, a bill acceptor, a magnetic strip reader, and a bar code scanner.
